(19) United States
(12) Patent Application Publication
(10) Pub. No.: US 2025/0085190 A1
(43) Pub. Date: Mar. 13, 2025

(54) DIAGNOSTIC APPARATUS, DIAGNOSTIC METHOD, AND STORAGE MEDIUM STORING DIAGNOSTIC PROGRAM

(71) Applicant: KABUSHIKI KAISHA TOSHIBA, Tokyo (JP)

(72) Inventors: Tatsuhiko Goto, Kawasaki Kanagawa (JP); Akihiko Enamito, Kawasaki Kanagawa (JP); Osamu Nishimura, Kawasaki Kanagawa (JP)

(73) Assignee: KABUSHIKI KAISHA TOSHIBA, Tokyo (JP)

(21) Appl. No.: 18/764,799

(22) Filed: Jul. 5, 2024

(30) Foreign Application Priority Data
Sep. 13, 2023 (JP) 2023-148675

(51) Int. Cl. G01M 7/02

(52) U.S. Cl. CPC G01M 7/025

(57) ABSTRACT

A diagnostic apparatus includes an excitation unit, a first sound reception unit, a second sound reception unit, and a processor. The processor designates a plurality of various volumes for the excitation unit. The processor calculates a first reference impulse response, a second reference impulse response, a first evaluation impulse response, and a second evaluation impulse response. The processor calculates a correlation transfer function. The processor calculates a difference between a first evaluation characteristic and a first reference characteristic. The processor diagnoses a measurement object based on the difference and a characteristic that a volume of a vibration radiation sound shifts from a dead zone to a rise region to a linear region to a saturation zone in this order as a volume of the excitation sound changes.

### CROSS-REFERENCE TO RELATED APPLICATIONS

This application is based upon and claims the benefit of priority from the Japanese Patent Application No. 2023-148675, filed Sep. 13, 2023, the entire contents of which are incorporated herein by reference.

### FIELD

Embodiments described herein relate generally to a diagnostic apparatus, a diagnostic method, and a storage medium storing a diagnostic program.

### BACKGROUND

As a deterioration over time in a structure such as a building or in infrastructure, a change may occur in rigidity due to a change in welding and joining conditions in the structure, in structural damping characteristics due to peeling of an internal coating such as a damping material, and in strength due to rust, cracks, and cavitation of internal structures. Conventionally, as a diagnosis of such a deterioration, deterioration evaluation has been performed by audible evaluation using periodic hammering sounds. Other than that, automatic diagnoses such as a contact diagnosis using ultrasonic waves, a contact diagnosis using an acoustic emission (AE) sensor, a contact diagnosis using a magnetic sensor, deterioration evaluation using images, Fa diagnosis using radar, a diagnosis using a thermography, etc., are also known. Many of these automatic diagnoses are contact diagnoses. Furthermore, some of these automatic diagnoses cannot achieve diagnostic accuracy of the same level as a diagnosis using hammering sounds.

The embodiments provide a diagnostic apparatus, a diagnostic method, and a diagnostic program that are capable of achieving diagnostic accuracy of the same level as a diagnosis using hammering sounds through no contact.

### BRIEF DESCRIPTION OF THE DRAWINGS

FIG. 1 is a diagram for explaining a principle of an embodiment.

FIG. 2 contains graphs each showing a volume change characteristic of a sound from a measurement object at the time when the measurement object is excited by an excitation unit.

FIG. 3 is a block diagram showing a configuration of an example of a diagnostic apparatus according to an embodiment.

FIG. 4 is a diagram showing a hardware configuration of an example of a control device.

FIG. 5 is a flowchart showing an operation of a diagnostic method using the diagnostic apparatus according to the embodiment.

FIG. 6A is a diagram showing a measurement result of an example of a frequency characteristic of a vibration radiation sound with each evaluation volume for a sample A.

FIG. 6B is a diagram showing a measurement result of an example of a frequency characteristic of a vibration radiation sound with each evaluation volume for a sample B.

FIG. 6C is a diagram showing a measurement result of an example of a frequency characteristic of a vibration radiation sound with each evaluation volume for a sample C.

FIG. 6D is a diagram showing a measurement result of an example of a frequency characteristic of a vibration radiation sound with each evaluation volume for a sample D.

FIG. 7 is a schematic diagram of a sample used for measurement.

FIG. 8 is a diagram showing a comparison result of a volume change characteristic of a vibration radiation sound of 1250 Hz for each sample.

FIG. 9 is a diagram illustrating a comparison between a volume change characteristic of a vibration radiation sound on which volume correction has not been performed and a volume change characteristic of a vibration radiation sound on which volume correction has been performed.

FIG. 10A is a diagram illustrating an example of the frequency characteristic of the vibration radiation sound with each evaluation volume for the sample A.

FIG. 10B is a diagram illustrating an example of the frequency characteristic of the vibration radiation sound with each evaluation volume for the sample B.

FIG. 10C is a diagram illustrating an example of the frequency characteristic of the vibration radiation sound with each evaluation volume for the sample C.

FIG. 10D is a diagram illustrating an example of the frequency characteristic of the vibration radiation sound with each evaluation volume for the sample D.

FIG. 11 is a diagram regarding a volume at which volume linearity is maintained and illustrating a comparison among the frequency characteristic of the vibration radiation sound of the sample A, the frequency characteristic of the vibration radiation sound of the sample B, the frequency characteristic of the vibration radiation sound of the sample C, and the frequency characteristic of the vibration radiation sound of the sample D.

FIG. 12 is a block diagram illustrating a configuration of an example of a diagnostic apparatus according to a first modification of the embodiment.

FIG. 13 is a diagram illustrating measurement of a vibration radiation sound while an applied mass is attached to a measurement object.

### DETAILED DESCRIPTION

According to one embodiment, a diagnostic apparatus includes an excitation unit, a first sound reception unit, a second sound reception unit, and a processor. The excitation unit radiates an excitation sound to a measurement object. The first sound reception unit is arranged in a vicinity of the measurement object and receives a sound including a vibration radiation sound of the measurement object caused by radiation of the excitation sound. The second sound reception unit is arranged in a vicinity of the excitation unit and receives the excitation sound. The processor including hardware. The processor designates a plurality of various volumes for the excitation unit. The processor calculates a first reference impulse response, a second reference impulse response, a first evaluation impulse response, and a second evaluation impulse response. The first reference impulse response is based on a first reference signal output from the first sound reception unit in response to radiation of an excitation sound with a reference volume at which the vibration radiation sound is not radiated from the measurement object. The second reference impulse response is based on a second reference signal output from the second sound reception unit in response to radiation of an excitation sound with the reference volume. The first evaluation impulse response is based on a first evaluation signal output from the first sound reception unit in response to radiation of excitation sounds with at least two evaluation volumes greater than the reference volume. The second evaluation impulse response is based on a second evaluation signal output from the second sound reception unit in response to radiation of the excitation sounds with the evaluation volumes. The processor calculates a correlation transfer function between a second reference characteristic based on the second reference impulse response and a second evaluation characteristic based on the second evaluation impulse response. The processor calculates, based on the correlation transfer function, a difference between a first evaluation characteristic based on the first evaluation impulse response and a first reference characteristic based on the first reference impulse response. The processor diagnoses the measurement object based on the difference and a characteristic that a volume of the vibration radiation sound shifts from a dead zone to a rise region to a linear region to a saturation zone in this order as a volume of the excitation sound changes.

Hereinafter, embodiments will be described with reference to the drawings. First, an overview of a diagnostic apparatus according to an embodiment will be explained. The diagnostic apparatus according to the embodiment enables non-contact diagnosis to achieve diagnostic accuracy at the same level as a diagnosis using a hammering sound. A diagnosis using hammering sounds has disadvantages including the risk of damaging an object due to contact involved in the diagnosis, and lack of uniformity due to a hammering force and auditory evaluation depending on an operator's experience of many years.

On the other hand, according to the embodiment, a measurement object is vibrated by radiating an excitation sound with a certain volume from an excitation unit such as a speaker. A diagnosis is then performed on the measurement object by using a minute vibration radiation sound which is radiated from the measurement object as the measurement object vibrates. In this respect, the embodiment utilizes, for a diagnosis, such a characteristic that a volume of a vibration radiation sound from a measurement object shifts from a dead zone to a rise region to a linear region to a saturation zone in this order as a volume of an excitation sound changes. Specifically, the normality or abnormality of the measurement object is determined by acoustically exciting the measurement object while changing a volume, and capturing a change in volume of a vibration radiation sound for each excitation volume. The vibration radiation sound reflects a change in the internal structure, too. Accordingly, the diagnosis of the measurement object according to the embodiment can capture a change that cannot be determined from an image of a surface of a structure.

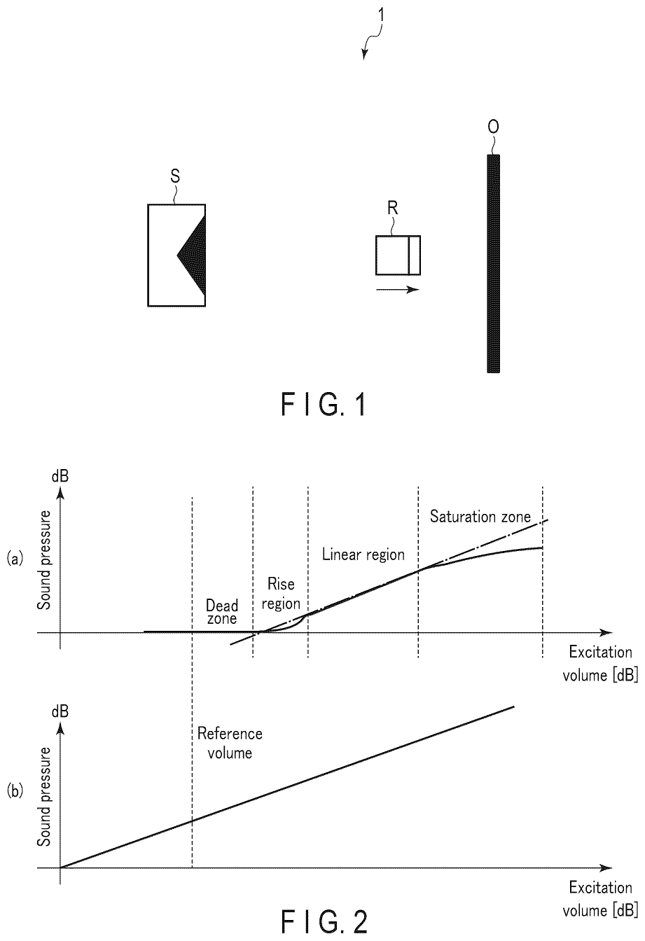

FIG. 1 is a diagram for explaining a principle of the embodiment. A diagnostic apparatus 1 includes an excitation unit S and a sound reception unit R. The vibration unit S is, for example, a speaker arranged to face a measurement object O, which is a structure such as a building or an infrastructure structure, and is configured to radiate an excitation sound to the measurement object O. The sound reception unit R is, for example, a microphone configured to receive a vibration radiation sound from the measurement object O.

FIG. 2 contains a graph (a) and a graph (b) each showing the volume change characteristic of a sound from the measurement object O at the time when the measurement object O is vibrated by the excitation unit S. Each of the horizontal axes in the graphs (a) and (b) of FIG. 2 represents a volume of the excitation sound, that is, a sound pressure level of excitation sound relative to a reference sound. Herein, a sound pressure level of the reference sound is set to a sound pressure level at which no vibration radiation sound is generated even by acoustic excitation by the excitation unit S. On the other hand, each of the vertical axes in the graphs (a) and (b) of FIG. 2 represents a volume of a sound from the measurement object O, that is, a sound pressure level of sound relative to a reference sound.

In actuality, the sound from the measurement object O at the time when the measurement object O is vibrated by the excitation unit S includes a vibration radiation sound and a reflected sound. The vibration radiation sound is a sound which is radiated from the measurement object O as the measurement object O vibrates upon receipt of a sound radiated thereto. The reflected sound is a sound which is reflected from the measurement object O upon receipt of an excitation sound radiated thereto. In FIG. 2, the graph (a) shows the volume change characteristics of the vibration radiation sound, and the graph (b) shows the volume change characteristics of the reflected sound.

In a case where the measurement object O is acoustically vibrated by the excitation unit S, the volume of the vibration radiation sound from the measurement object O shifts from a dead zone to a rise region to a linear region to a saturation zone in this order as the volume of the excitation sound changes, as shown in the graph (a) of FIG. 2. The dead zone is a region in which the volume of the vibration radiation sound is approximately the reference volume. The rise region is a region after the dead zone, in which the volume of the vibration radiation sound rapidly increases from the reference volume. The linear region is a region after the rise region, in which the volume of the vibration radiation sound increases almost linearly as the excitation volume changes. The saturation zone is a region after the linear region, in which the volume of the vibration radiation sound is saturated. In the embodiment, the normality or abnormality of the measurement object is determined by capturing a change in vibration radiation sound for each excitation volume.

The vibration radiation sound is weaker than the reflected sound. Therefore, in the sound acquired by the sound reception unit R, the vibration radiation sound is buried in the reflected sound. Herein, as shown in the graph (b) of FIG. 2, the volume of the reflected sound changes linearly with respect to the volume of the excitation sound. The volume of the excitation sound is known. Thus, only the vibration radiation sound can be extracted by applying a sound pressure difference to a signal received by the sound reception unit R. This realizes a diagnosis using vibrational radiation sound.

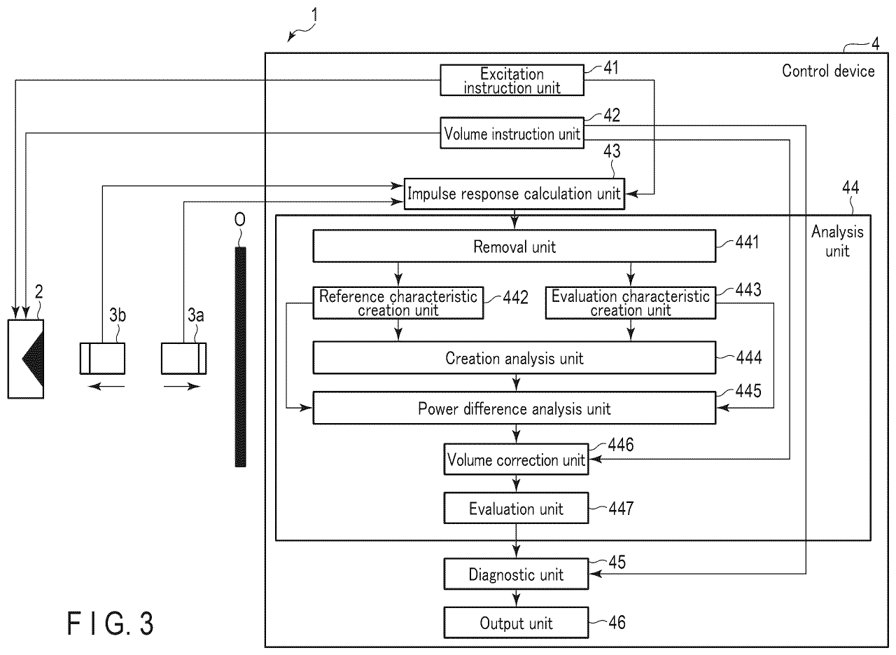

Hereinafter, a specific configuration of the diagnosis apparatus according to the embodiment will be described. FIG. 3 is a block diagram showing a configuration of an example of the diagnostic apparatus according to the embodiment. The diagnostic apparatus 1 includes a speaker 2, microphones 3a and 3b, and a control device 4.

The speaker 2 is an example of the excitation unit S, is arranged to face the measurement object O, and radiates the excitation sound to the measurement object O. An acoustic excitation signal for generating an excitation sound of the speaker 2 is applied by an excitation instruction unit 41 of a control device 4. Furthermore, a volume of the excitation sound is designated by a volume instruction unit 42 of the control device 4. The speaker 2 generates the excitation sound by amplifying the acoustic excitation signal applied from the excitation instruction unit 41 with a gain corresponding to the volume designated by the volume instruction unit 42. The speaker 2 then radiates the generated excitation sound to the measurement object O.

The microphone 3a is an example of the sound reception unit R, and is arranged in the vicinity of the measurement object O, receives a sound from the measurement object O, and generates a sound reception signal. The microphone 3b is arranged in the vicinity of the speaker 2, receives the excitation sound directly radiated from the speaker 2, and generates a sound reception signal. Herein, it is desirable that both the microphone 3a and the microphone 3b have directivity. As a microphone having directivity, a unidirectional microphone in which a microphone cap or the like having cardioid directivity is attached to the microphone, a superdirectional microphone such as a gun microphone or a line array microphone, and so on are usable.

As described above, in the embodiment, the volume of the speaker 2 is changed in order to extract the vibration radiation sound. However, the volume of the excitation sound radiated from the speaker 2 does not change linearly with respect to the change in the volume of the speaker 2. For example, even if a gain of the acoustic excitation signal is increased by 3 dB, the volume of the excitation sound radiated from the speaker 2 does not increase by 3 dB at all frequencies. This generates the necessity of monitoring a change in the volume of the excitation sound radiated from the speaker 2 with respect to a change in the volume of the speaker 2. The microphone 3b is provided to monitor this change.

The control device 4 is a computer configured to diagnose the measurement object O by processing sound signals from the microphones 3a and 3b. The control device 4 includes the excitation instruction unit 41, the volume instruction unit 42, an impulse response calculation unit 43, an analysis unit 44, a diagnostic unit 45, and an output unit 46.

The excitation instruction unit 41 applies an acoustic vibration signal to the speaker 2 in order to instruct the speaker 2 to radiate a vibration sound. The acoustic excitation signal may be any signal. For example, the acoustic excitation signal may be a time stretched pulse (TSP) signal or a random signal.

The volume instruction unit 42 instructs the speaker 2 about the volume of the excitation sound. The volume is selected from predetermined volumes. Herein, in the embodiment, the volume instruction unit 42 instructs the speaker 2 to set a different volume each time the speaker 2 radiates excitation sound. The predetermined volume may include a reference volume and at least two evaluation volumes that are larger than the reference volume. However, as described above, in the embodiment, it is desirable that the number of evaluation volumes be large in order to fully utilize the characteristic that the volume of vibration radiation sound shifts from the dead zone to the rise region to the linear region to the saturation zone in this order as the volume of excitation sound changes.

The impulse response calculation unit 43 calculates an impulse response between the acoustic excitation signal applied by the excitation instruction unit 41 and the sound reception signal obtained by the microphone 3a. Furthermore, the impulse response calculation unit 43 calculates an impulse response between the acoustic excitation signal applied by the excitation instruction unit 41 and the sound reception signal obtained by the microphone 3b. In the following, the impulse response calculated from the sound reception signal obtained by the microphone 3a at the time when the excitation sound of the reference volume is radiated will be referred to as a “first reference impulse response”. The impulse response calculated from the sound reception signal obtained by the microphone 3b at the time when the excitation sound of the reference volume is radiated will be referred to as a “second reference impulse response”. The impulse response calculated from the sound reception signal obtained by the microphone 3a at the time when the excitation sound of the evaluation volume is radiated will be referred to as a “first evaluation impulse response”. The impulse response calculated from the sound reception signal obtained by the microphone 3b at the time when the excitation sound of the evaluation volume is radiated will be referred to as a “second evaluation impulse response”.

The analysis unit 44 performs analysis on the impulse response calculated by the impulse response calculation unit 43. The analysis unit 44 includes a removal unit 441, a reference characteristic creation unit 442, an evaluation characteristic creation unit 443, a correlation analysis unit 444, a power difference analysis unit 445, a volume correction unit 446, and an evaluation unit 447.

The removal unit 441 removes a multiple reflection component between the speaker 2 and the measurement object O in each of the first reference impulse response, the second reference impulse response, the first evaluation impulse response, and the second evaluation impulse response, and outputs each impulse response from which the multiple reflection component has been removed to the reference characteristic creation unit 442 and the evaluation characteristic creation unit 443. Specifically, the removal unit 441 keeps components up to a predetermined time including a peak component in each of the first reference impulse response, the second reference impulse response, the first evaluation impulse response, and the second evaluation impulse response, and removes, as a multiple reflection component, a component that exceeds the predetermined time. Removal can be performed by, for example, zero-filling of a multiple reflection component.

The reference characteristic creation unit 442 creates a reference characteristic based on the first reference impulse response and the second reference impulse response. For example, the reference characteristic creation unit 442 holds, as the first reference characteristic, the first reference impulse response from which a multiple reflection component output from the removal unit 441 has been removed, and also holds, as the second reference characteristic, the second reference impulse response from which a multiple reflection component output from the removal unit 441 has been removed. Alternatively, the reference characteristic creation unit 442 may hold, as the first reference characteristic and the second reference characteristic, frequency characteristics converted from the first reference impulse response and the second reference impulse response.

The evaluation characteristic creation unit 443 creates evaluation characteristics based on the first evaluation impulse response and the second evaluation impulse response. For example, the evaluation characteristic creation unit 443 holds, as the first evaluation characteristic, the first evaluation impulse response for each evaluation volume, from which a multiple reflection component output from the removal unit 441 has been removed, and also holds, as the second evaluation characteristic, the second evaluation impulse response for each evaluation volume, from which a multiple reflection component output from the removal unit 441 has been removed. Alternatively, the evaluation characteristic creation unit 443 may hold, as the first evaluation characteristic and the second evaluation characteristic, frequency characteristics converted from the first evaluation impulse response and the second evaluation impulse response.

The correlation analysis unit 444 performs a correlation analysis of the impulse response with respect to the microphone 3b that receives the excitation sound from the speaker 2. Specifically, the correlation analysis unit 444 performs correlation processing between the second reference characteristic and the second evaluation characteristic for each evaluation sound volume, and derives a correlation transfer function corresponding to the ratio of the second reference characteristic with each second evaluation characteristic.

The power difference analysis unit 445 calculates a power difference between the first evaluation characteristic and the first reference characteristic for each evaluation volume. The first reference characteristic corresponds to the characteristic of the reflected sound from the measurement object O. Thus, a difference in power between the first evaluation characteristic and a signal obtained by multiplying the first reference characteristic by a difference in volume between the reference volume and the evaluation volume corresponds to a power of only the vibration radiation sound from the measurement object O. However, as described above, the volume of the excitation sound radiated from the speaker 2 does not change linearly in response to a change in volume of the speaker 2. Thus, the power difference analysis unit 445 calculates a difference in power using the correlation transfer function derived by the correlation analysis unit 444. Specifically, the power difference analysis unit 445 calculates a power difference by (first evaluation characteristic)−(first reference characteristic)×(correlation transfer function). The microphone 3b may be omitted, although the accuracy of diagnosis lowers as compared to the case in which two microphones are used, if the difference in power between the first evaluation characteristic and the signal obtained by multiplying the first reference characteristic by the difference in volume between the reference volume and the evaluation volume is handled as a power of only the vibration radiation sound from the measurement object O.

The volume correction unit 446 performs volume correction on the power of the vibration radiation sound obtained by the power difference analysis unit 445. As the evaluation volume increases, the volume of the vibration radiation sound increases. In order to facilitate comparison between vibration radiation sounds, the volume correction unit 446 calculates (power of vibration radiation sound)−((evaluation volume)−(reference volume)) as volume correction. The evaluation volume and reference volume are the reference volume and evaluation volume designated by the volume instruction unit 42.

The evaluation unit 447 converts the power characteristic corrected by the volume correction unit 446 into a power frequency characteristic of a power of an octave band or a ⅓ octave band in order to evaluate a power of the vibration radiation sound. For example, the evaluation unit 447 obtains the frequency characteristic of power using fast Fourier transformation (FFT).

The diagnostic unit 45 diagnoses the measurement object O using the frequency characteristic of the vibration radiation sound obtained by the evaluation unit 447. Diagnosis of the measurement object O will be explained in detail later.

The output unit 46 outputs the diagnosis result by the diagnostic unit 45. Output may be performed by various methods, such as displaying of a diagnostic result on a display device or printing of a diagnostic result with a printer. The diagnosis result may include, for example, information on the presence or absence of an abnormality in the measurement object O, and with the presence of such an abnormality, information on the location of the abnormality.

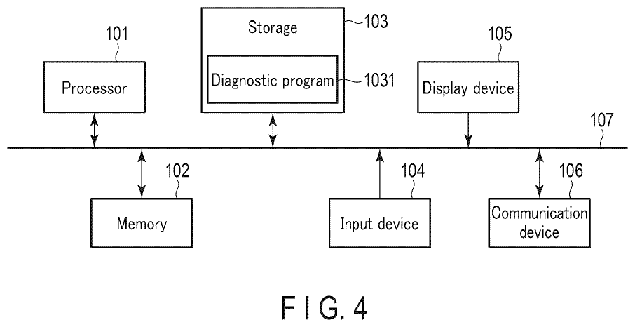

FIG. 4 is a diagram showing a hardware configuration of an example of the control device 4. The control device 4 may be a computer that includes, as hardware, a processor 101, a memory 102, a storage 103, an input device 104, a display 105, and a communication device 106. The processor 101, the memory 102, the storage 103, the input device 104, the display 105, and the communication device 106 are connected to a bus 107. The control device 4 may be installed in a terminal device such as a personal computer (PC), a smartphone, or a tablet terminal.

The processor 101 is a processor that controls the overall operation of the control device 4. For example, by executing a diagnostic program 1031 stored in the storage 103, the processor 101 operates as the excitation instruction unit 41, the volume instruction unit 42, the impulse response calculation unit 43, the analysis unit 44, the diagnostic unit 45, and the output unit 46. The processor 101 may be, for example, a CPU. The processor 101 may be an MPU, a GPU, an ASIC, an FPGA, etc. The processor 101 may be, for example, either a single CPU or a plurality of CPUs.

The memory 102 includes a ROM and a RAM. The ROM is a nonvolatile memory. The ROM stores a boot program, etc. for the control device 4. The RAM is a volatile memory. In one example, the RAM is used as a working memory for the processor 101 to perform its processing.

The storage 103 is a storage such as a flash memory, a hard disk drive, a solid-state drive, etc. The storage 103 stores various types of programs executed by the processor 101, such as a diagnostic program. Furthermore, the storage 103 may be configured to store a diagnostic result with respect to the measurement object O.

The input device 104 is an input device such as a touch panel, a keyboard, a mouse, etc. When an operation is made via the input device 104, a signal corresponding to details of the operation is input via the bus 107 to the processor 101. The processor 101 performs various types of processing in response to this signal.

The display 105 is a display such as a liquid crystal display, an organic EL display, etc. The display 105 displays various types of images.

The communication device 106 is a communication device for the control device 4 to communicate with external equipment. The communication device 106 may be a communication module for either wired or wireless communications. The communication device 106 is usable for, for example, transmission of an acoustic excitation signal and a gain corresponding to a volume to the speaker 2 and reception of reception signals from the microphones 3a and 3b.

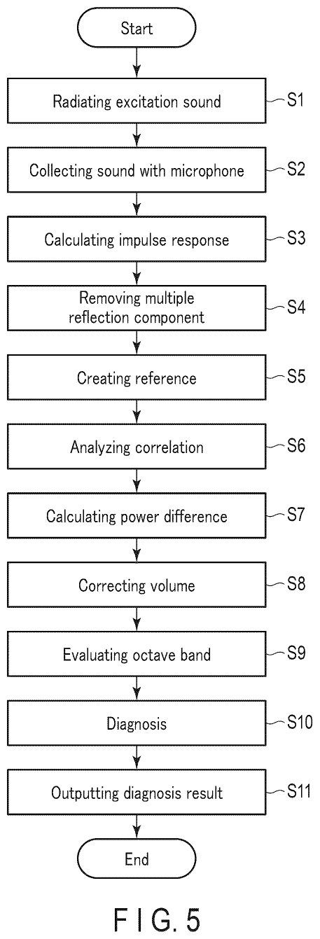

FIG. 5 is a flowchart showing an operation of a diagnostic method using the diagnostic apparatus 1 according to the embodiment. The operation shown in FIG. 5 is controlled by the control device 4.

In step S1, the control device 4 radiates the excitation sound from the speaker 2 to the measurement object O. First, the volume instruction unit 42 designates a reference volume as a volume for the speaker 2. The excitation instruction unit 41 instructs emission of the excitation sound with the reference volume from the speaker 2 by inputting the acoustic excitation signal to the speaker 2. Next, the volume instruction unit 42 designates, as a volume for the speaker 2, one of the evaluation volumes. The excitation instruction unit 41 instructs emission of the excitation sound with the evaluation volume from the speaker 2 by inputting the acoustic excitation signal to the speaker 2. Hereinafter, the volume instruction unit 42 successively designates one of the evaluation volumes as a volume for the speaker 2 while the excitation instruction unit 41 instructs emission of the excitation sound with the evaluation volume from the speaker 2 by inputting the acoustic excitation signal to the speaker 2.

In step S2, the impulse response calculation unit 43 receives the sound reception signals from the microphones 3a and 3b every time the excitation sound is radiated from the speaker 2 to the measurement object O.

In step S3, the impulse response calculation unit 43 calculates impulse responses for each of the microphones 3a and 3b from the sound reception signals acquired from the microphones 3a and 3b.

In step S4, the removal unit 441 removes a multiple reflection component in the impulse response for each of the microphones 3a and 3b by a method such as, for example, zero-filling.

In step S5, the reference characteristic creation unit 442 creates a reference characteristic based on the first reference impulse response and the second reference impulse response obtained by the removal unit 441 at the time when the excitation sound of the reference volume is radiated. Alternatively, in step S5, the evaluation characteristic creation unit 443 creates an evaluation characteristic for each evaluation volume based on the first evaluation impulse response and the second evaluation impulse response obtained by the removal unit 441 at the time when the excitation sound of each evaluation volume is radiated. For example, at the first time, that is, at the time when the excitation sound with the reference volume is radiated, the reference characteristic creation unit 442 holds output of the removal unit 441 as a reference characteristic. At the second and subsequent times, that is, at the time when the excitation sound with the evaluation volume is radiated, the evaluation characteristic creation unit 443 holds output of the removal unit 441 as an evaluation characteristic. Alternatively, the reference characteristic creation unit 442 may convert the first reference impulse response and the second reference impulse response into frequency characteristics and hold them as the reference characteristics, and the evaluation characteristic creation unit 443 may convert the first evaluation impulse response and the second evaluation impulse response into frequency characteristics and hold them as the evaluation characteristics.

In step S6, the correlation analysis unit 444 performs correlation processing between the second reference characteristic for the microphone 3b and the second evaluation characteristic for each evaluation volume, and derives a correlation transfer function for each evaluation volume.

In step S7, the power difference analysis unit 445 calculates a power difference between the first evaluation characteristic for the microphone 3a held in the evaluation characteristic creation unit 443 and the first reference characteristic for the microphone 3a held in the reference characteristic creation unit 442 by using a correlation transfer function for each evaluation characteristic.

In step S8, the volume correction unit 446 performs volume correction on the power calculated by the power difference analysis unit 445, based on the evaluation volume and the reference volume designated by the volume instruction unit 42.

In step S9, the evaluation unit 447 converts the power characteristic corrected by the volume correction unit 446 into an octave band frequency characteristic.

In step S10, the diagnostic unit 45 performs a diagnosis on the measurement object O from the power characteristic for each evaluation sound volume obtained by the evaluation unit 447. Details of the diagnosis will be explained later.

In step S11, the output unit 46 outputs a diagnosis result to, for example, a display device. Thereafter, the processing shown in FIG. 5 ends. The output unit 46 causes the display device to display, as the diagnosis result, for example, information on the presence or absence of an abnormality in the measurement object O, and with the presence of such an abnormality, information on the location of the abnormality. Other than the above, the output unit 46 may cause the display device to display a graph of volume change characteristics and a graph of frequency characteristics, which will be described later.

The diagnosis in step S10 will be described below. The diagnosis in the embodiment includes a first diagnosis and a second diagnosis. Only one of the first diagnosis and the second diagnosis may be performed, or both may be performed.

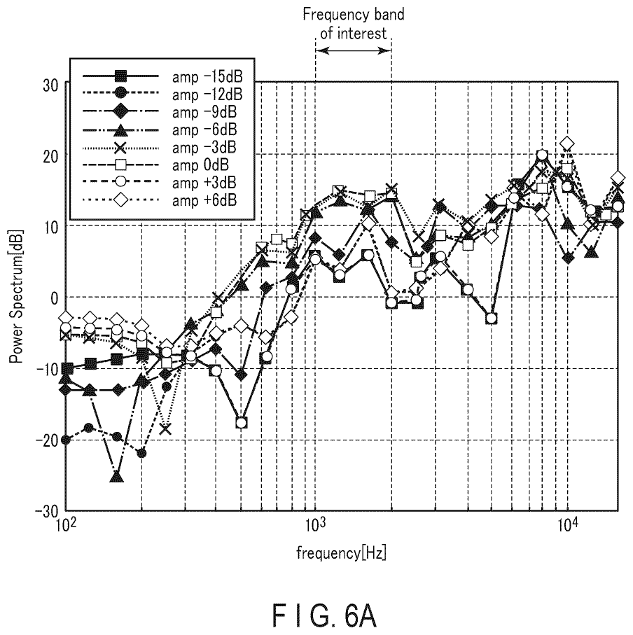

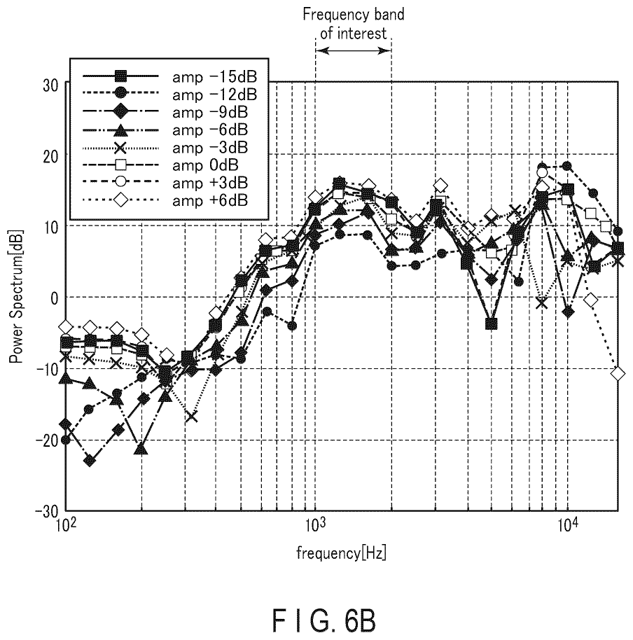

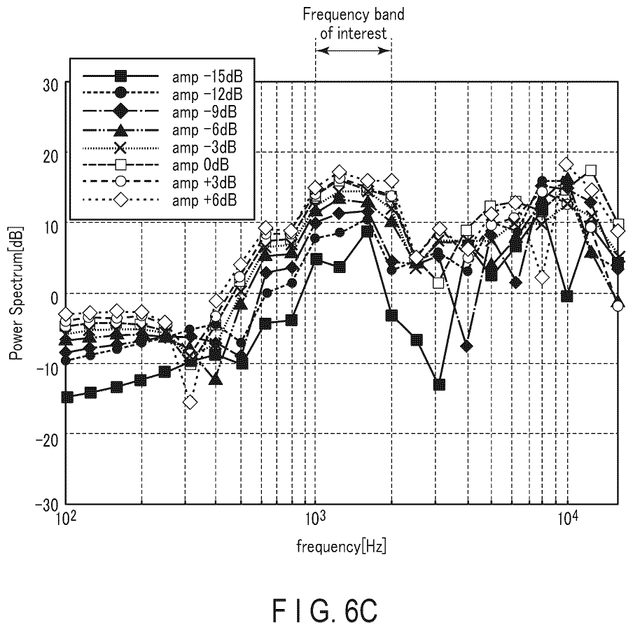

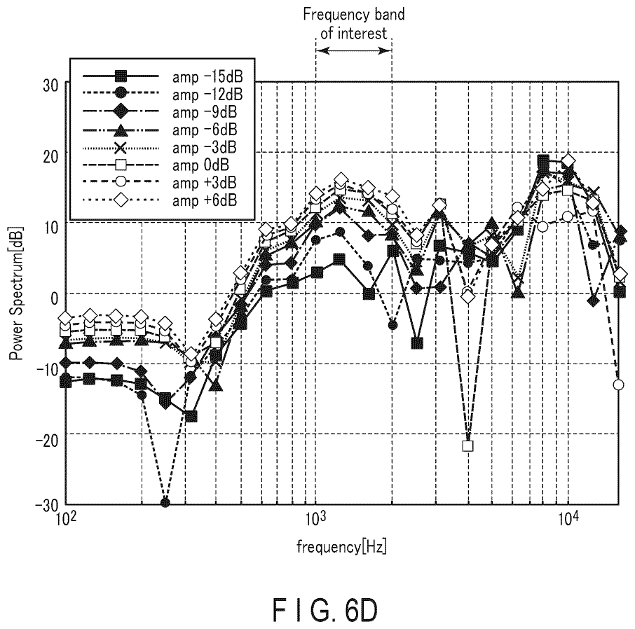

First, the first diagnosis will be described. FIG. 6A, FIG. 6B, FIG. 6C, and FIG. 6D are diagrams each showing an example of a measurement result of the frequency characteristic (reflecting volume correction by the volume correction unit 446) of the vibration radiation sound with each evaluation volume obtained by the evaluation unit 447. The horizontal axis in each of FIG. 6A, FIG. 6B, FIG. 6C, and FIG. 6D represents a ⅓ octave band frequency, and the vertical axis in each of FIG. 6A, FIG. 6B, FIG. 6C, and FIG. 6D represents a power of the vibration radiation sound. FIG. 6A shows the frequency characteristic of the vibration radiation sound for the sample A, which imitates a structure with no abnormality. On the other hand, FIG. 6B, FIG. 6C, and FIG. 6D each show the frequency characteristic of the vibration radiation sound for the samples B, C, and D, which imitate a structure with an abnormality.

Herein, measurement conditions for the frequency characteristics in FIG. 6A, FIG. 6B, FIG. 6C, and FIG. 6D are that the distance between the microphone 3a and the measurement object O is 15 mm, and the distance between the microphone 3b and the speaker 2 is 60 mm. Furthermore, the distance between the speaker 2 and the measurement object O is 330 mm. The reference volume is −18 dB, and the evaluation volumes are −15 dB, −12 dB, −9 dB, . . . , 0 dB, 3 dB, 6 dB (in 9 levels in 3 dB increments).

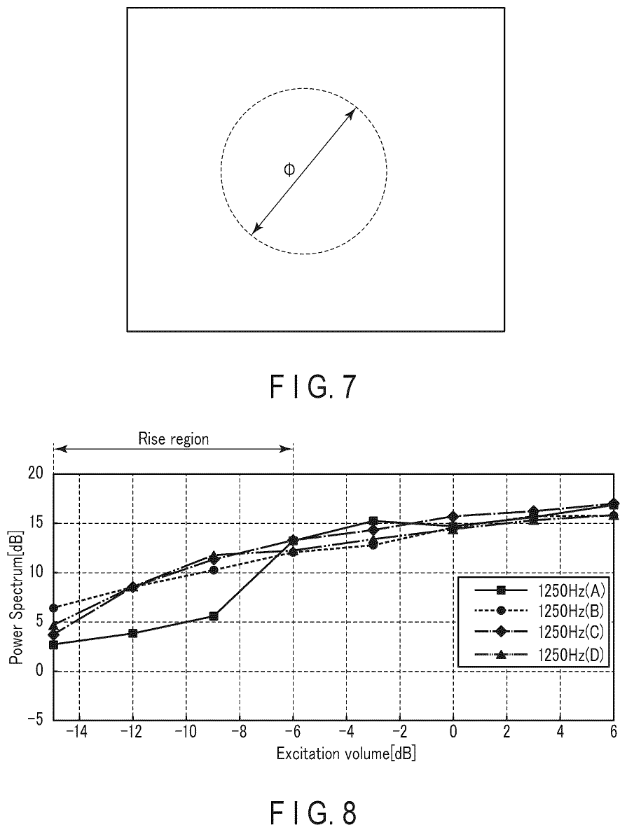

FIG. 7 is a schematic diagram of a sample used for measurement. As a sample, a piece of concrete, which is often used in buildings, is used. As the sample A, a piece of concrete not specially processed is used. On the other hand, as the samples B, C, and D, pieces of concrete each containing a styrene board that imitates an internal cavity of a building in order to imitate a defect in the building are used. A styrene board is included in the position indicated by the broken line frame in FIG. 7. A diameter of the styrene board differs among the samples B, C, and D. On the other hand, an embedding position of the styrene board, that is, a cover thickness, is the same among the samples B, C, and D. The conditions for each of the samples used for measurement will be summarized below.
Sample A (normal): No styrene board
Sample B (abnormal): Cover thickness of 5 mm, φ200
Sample C (abnormal): Cover thickness of 5 mm, φ100
Sample D (abnormal): Cover thickness of 5 mm, φ50

As shown in FIG. 6A, FIG. 6B, FIG. 6C, and FIG. 6D, as the excitation sound is increased in volume, the lines begin to approximately overlap. This means that with the volume being increased to a certain extent, the vibration radiation sound enters a state in which its volume linearity is maintained. The state in which the volume linearity is maintained corresponds to a state in which the relationship between the power of the vibration radiation sound and the volume of the excitation sound belongs to the linear region in the volume change characteristic described above. For example, in FIG. 6A, the lines of −6 dB, −3 dB, 0 dB, +3 dB, and +6 dB approximately overlap. Furthermore, in FIG. 6B, FIG. 6C, and FIG. 6D, the lines of −9 dB, −6 dB, −3 dB, 0 dB, +3 dB, and +6 dB approximately overlap.

In the first diagnosis, a frequency band having a vibration radiation sound with a high power is set as a frequency band of interest, and the volume change characteristic of the vibration radiation sound is compared between the samples at a frequency included in the frequency band of interest. For example, in FIG. 6A, FIG. 6B, FIG. 6C, and FIG. 6D, the frequency band with a high-power vibration radiation sound is approximately 1000 Hz to 1600 Hz. Therefore, the diagnostic unit 45 compares the volume change characteristic of the vibration radiation sound between the samples at a frequency included in the aforementioned frequency band. Specifically, the diagnostic unit 45 extracts, for each volume of the excitation sound, a power of the vibration radiation sound at a specific frequency in the frequency band of interest in the frequency characteristic of the vibration radiation sound for each sample, and replots the extracted power of the vibration radiation sound with the horizontal axis representing the volume of the vibration radiation sound and the vertical axis representing the power of the vibration radiation sound.

FIG. 8 is a diagram showing a comparison result of volume change characteristics of the vibration radiation sounds of 1250 Hz (⅓ octave band) (with volume correction by the volume correction unit 446) between the samples. The sample A without an abnormality and the samples B, C, and D with an abnormality differ in the volume range in which volume linearity is maintained, that is, the volume that transitions from the rise region to the linear region. Herein, in FIG. 8, which corresponds to the diagnosis in step S10 based on the octave band evaluation in step S9, the linear region is classified as a region with an inclination close to 0 (in FIG. 8, the excitation volume is equal to or greater than −4 dB) because the processing of volume correction in step S8 has been performed. Therefore, a line presenting a power of the sample A in the rise region does not overlap with lines presenting powers of the samples B, C, and D. The presence or absence of an abnormality in the measurement object O may be diagnosed based on such a difference in the volume change characteristics. Furthermore, in a case where a diagnostic result shows the presence of an abnormality, a position of such an abnormality can be specified, for example, from a position on the measurement object O from which the excitation sound is radiated.

In actual diagnosis, the control device 4 collects the vibration radiation sound of a sample with no abnormalities in advance, identifies a frequency band of interest in which a power of a predetermined level or greater is obtained in the frequency characteristic obtained as a result of collecting the vibration radiation sound, and stores a volume change characteristic of the identified frequency band of interest. The control device 4 then collects the vibration radiation sound with respect to the measurement object O, and compares the volume change characteristic of the frequency band of interest of the measurement object O with the volume change characteristic of a sample with no abnormality, thereby diagnosing the presence or absence of an abnormality in the measurement object O. For example, in a case where a result of the comparison of the volume change characteristics between a sample with no abnormality and the measurement object O shows the presence of a volume range in which the volume change characteristics differ by a predetermined level or more, the control device 4 diagnoses that the measurement object O has an abnormality.

In the first diagnosis described above, the method of the shift of the vibration radiation sound from the dead zone to the rise region to the linear region to the saturation zone, which accompanies the change in volume of the excitation sound, differs depending on the presence or absence of an abnormality in the measurement object. Therefore, the presence or absence of an abnormality in the measurement object is diagnosed by comparing the volume change characteristic of the measurement object in the frequency band of interest with the volume change characteristic of a sample with no abnormality. For this reason, the presence or absence of an abnormality in the measurement object may be diagnosed through no contact. The vibration radiation sound reflects a change inside the measurement object also. This makes it possible to capture changes that cannot be determined from, e.g., images of the surface of the measurement object.

Furthermore, by the power difference analysis unit 445 removing a component of a reflected sound from the measurement object O, a comparison of volume change characteristics may be made using a minute vibration radiation sound.

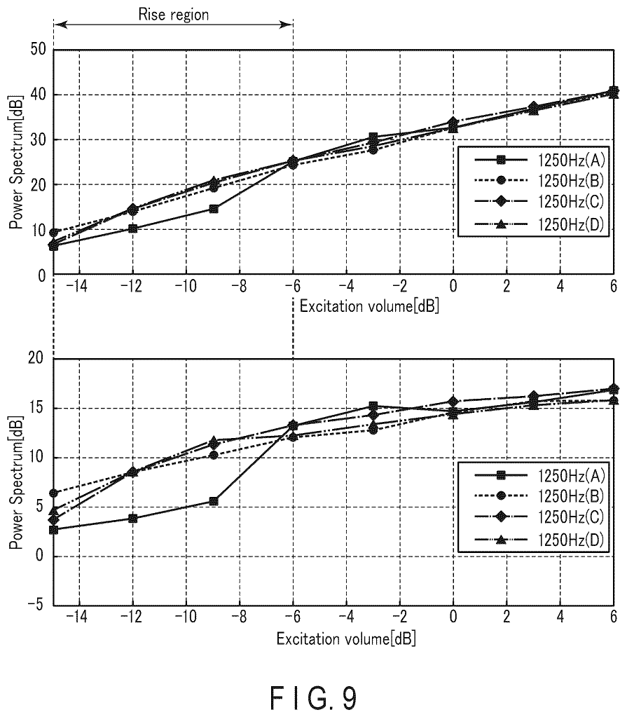

Furthermore, by the volume correction unit 446 performing volume correction, a difference in volume change characteristic between samples can be captured more easily. Hereinafter, the effects of the volume correction unit 446 will be described in detail. FIG. 9 is a diagram illustrating a comparison between a volume change characteristic of a vibration radiation sound on which volume correction has not been performed and a volume change characteristic of a vibration radiation sound on which volume correction has been performed. The upper graph in FIG. 9 shows the volume change characteristic of the vibration radiation sound on which volume correction has not been performed, and the lower graph shows the volume change characteristic of the vibration radiation sound on which volume correction has been performed. The vibration radiation sound increases linearly as the volume increases. Therefore, if the volume change characteristics are compared as they are, it is difficult to capture a difference in volume change characteristic between the samples. Correcting the linear increase through the volume correction makes it easy to capture a difference in volume change characteristic between the samples. The example shown in FIG. 9 shows a large difference between a change in power of the sample A, which corresponds to the rise region, and a change in power of each of the samples B, C, and D, which corresponds to the linear region.

Herein, the first diagnosis example described above makes a comparison of volume change characteristics for 1250 Hz in the frequency band of interest; however, such a comparison of volume change characteristics may be made for multiple frequencies in the frequency band of interest. By making a comparison of volume change characteristics for multiple frequencies in the frequency band of interest, a diagnosis as to the presence or absence of an abnormality is expected to become easier to make.

Furthermore, it is assumed that the samples used as an example of the first diagnosis described above are pieces of concrete in which styrene boards have different diameters and which imitate the measurement objects O having different defect sizes. On the other hand, the applicant has also performed the same first diagnosis on a plurality of types of concrete in which styrene boards have different cover thicknesses and which imitate the measurement object O having different depths of defects. As a result, the applicant has confirmed that the presence or absence of an abnormality can be diagnosed through the first diagnosis. That is, the presence or absence of various abnormalities may be diagnosed through the first diagnosis.

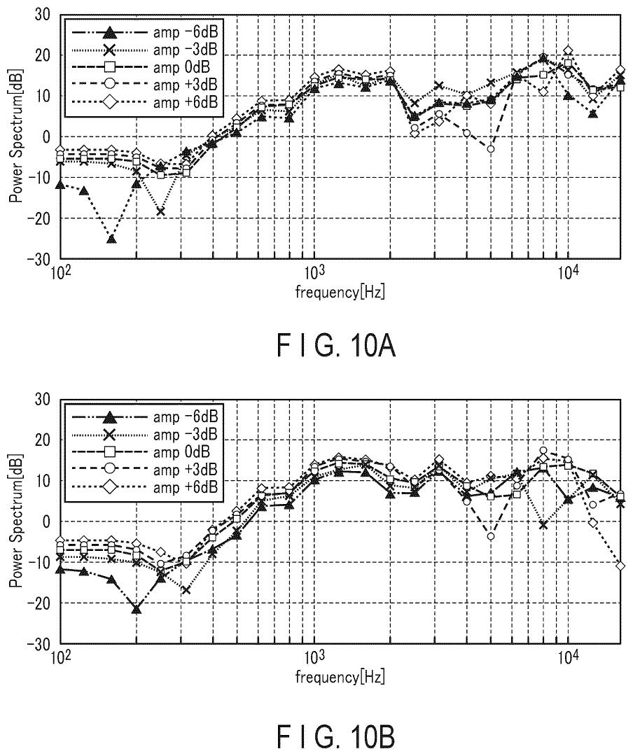

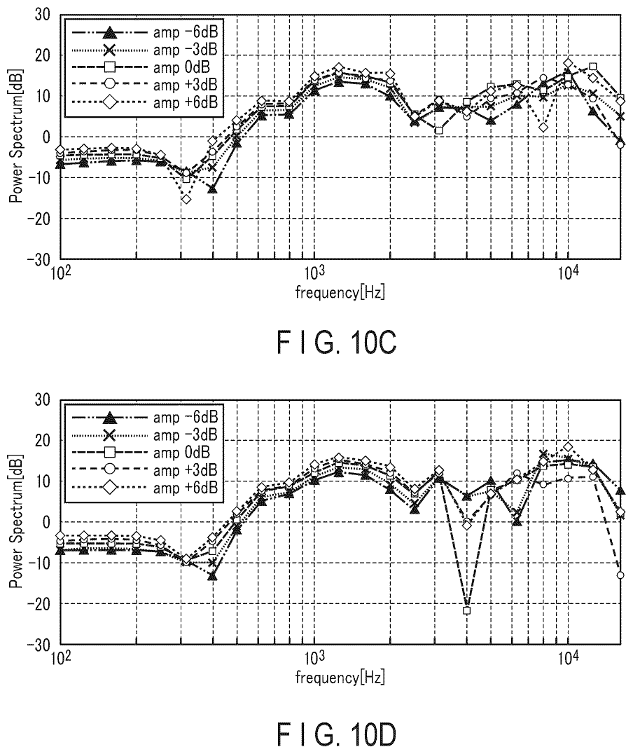

Next, the second diagnosis will be described. In the first diagnosis, the presence or absence of an abnormality in the measurement object O is diagnosed based on a difference in the volume change characteristics. In the second diagnosis, a diagnosis is performed by comparing a frequency characteristic of a vibration radiation sound of an evaluation volume of interest which is set to a volume at which volume linearity is maintained. FIG. 10A, FIG. 10B, FIG. 10C, and FIG. 10D are diagrams each showing an example of the frequency characteristic of the power of the vibrating radiation sound at each evaluation volume (volume at which volume linearity is maintained) obtained by the evaluation unit 447. The horizontal axis in each of FIG. 10A, FIG. 10B, FIG. 10C, and FIG. 10D represents a ⅓ octave band frequency, and the vertical axis in each of FIG. 10A, FIG. 10B, FIG. 10C, and FIG. 10D represents a power of the vibration radiation sound. FIG. 10A shows the frequency characteristic of the vibration radiation sound for the sample A, which imitates a structure with no abnormality. On the other hand, FIG. 10B, FIG. 10C, and FIG. 10D each show the frequency characteristic of the vibration radiation sound for the samples B, C, and D, which simulate a structure with an abnormality. Herein, the measurement conditions for the frequency characteristics in FIGS. 10A, 10B, 10C, and 10D are the same as the measurement conditions for the frequency characteristics in FIGS. 6A, 6B, 6C, and 6D. Of the frequency characteristics shown in FIG. 6A, FIG. 6B, FIG. 6C, and FIG. 6D, FIG. 10A, FIG. 10B, FIG. 10C, and FIG. 10D each show only the frequency characteristic of a volume at which volume linearity is maintained, that is, a volume at which lines presenting powers overlap.

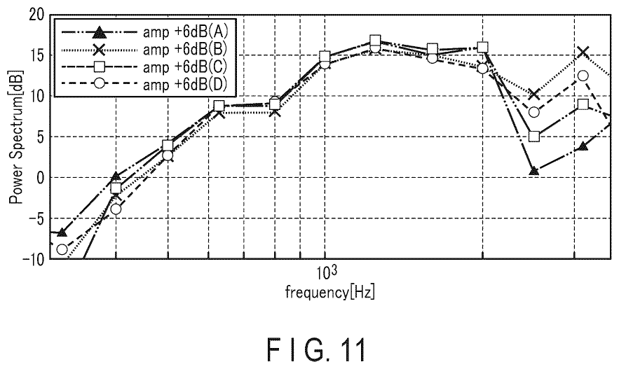

FIG. 11 is a diagram illustrating a comparison among the frequency characteristic of the vibration radiation sound of the sample A, the frequency characteristic of the vibration radiation sound of the sample B, the frequency characteristic of the vibration radiation sound of the sample C, and the frequency characteristic of the vibration radiation sound of the sample D, regarding a volume at which volume linearity is maintained. In FIG. 11, of the volumes at which volume linearity is maintained, +6 dB is selected as the evaluation volume of interest. A volume selected as the evaluation volume of interest may be another volume in which volume linearity is maintained.

As shown in FIG. 11, the frequency characteristics below a band of 2 kHz are approximately the same regardless of the sample. On the other hand, in a band of 2.5 kHz and a band of 3.1 kHz, a significant difference appears in the frequency characteristics between the samples. Specifically, the sample A with no abnormality is significantly lower in power than the samples B, C, and D with abnormalities. This indicates that the presence or absence of an abnormality in the measurement object O may be diagnosed by making a comparison of frequency characteristics of volumes at which volume linearity is maintained.

Furthermore, in FIG. 11, a remarkable difference appears in the frequency characteristics of the samples B, C, and D having abnormalities in the band of 2.5 kHz and the band of 3.1 kHz. As described above, the samples B, C, and D are different from each other in a diameter of styrene board. In other words, the fact that a remarkable difference appears in the frequency characteristics of the samples B, C, and D with abnormalities in the band of 2.5 kHz and the band of 3.1 kHz indicates that the degree of abnormality in the measurement object O may also be diagnosed by comparing the frequency characteristics pf volumes at which volume linearity is maintained. For example, the degree of abnormality may be diagnosed by accumulating a database of a relationship between the degree of abnormality and a frequency characteristic and comparing the degree of similarity between the frequency characteristic in this database and a frequency characteristic of a diagnostic object.

In actual diagnosis, the control device 4 collects the vibration radiation sound of a sample with no abnormality in advance, and for the sample with no abnormality based on the collected vibration radiation sound, causes the diagnostic unit 45 to store the frequency characteristic of a volume at which volume linearity is maintained. The control device 4 collects the vibration radiation sound with respect to the measurement object O, and compares the frequency characteristic of the volume at which volume linearity predetermined for the measurement object O is maintained with the frequency characteristic with respect to a sample with no abnormalities, thereby diagnosing the presence or absence of an abnormality in the measurement object O. For example, in a case where a result of the comparison of the frequency characteristics between a sample with no abnormality and the measurement object O shows the presence of a volume range in which the frequency characteristics differ by a predetermined level or more, the control device 4 diagnoses that the measurement object O has an abnormality.

In the second diagnosis described above, the presence or absence of an abnormality in a measurement object is diagnosed by comparing the frequency characteristic of the measurement object at a volume at which volume linearity is maintained with the frequency characteristic of a sample with no abnormality. For this reason, the presence or absence of an abnormality in the measurement object may be diagnosed through no contact. Furthermore, the vibration radiation sound reflects a change inside the measurement object also. This makes it possible to capture changes that cannot be determined from, e.g., images of the surface of the measurement object.

Furthermore, a component of the reflected sound from the measurement object O may be removed by the power difference analysis unit 445. Therefore, a comparison of volume change characteristics may be made using a minute vibration radiation sound.

Herein, the second diagnosis example described above makes a comparison of frequency characteristics for +6 dB as a volume at which volume linearity is maintained; however, such a comparison of feature characteristics may be made for multiple volumes of the volumes at which volume linearity is maintained. By making a comparison of frequency characteristics for multiple volumes of the volumes at which volume linearity is maintained, a diagnosis as to the presence or absence of an abnormality is expected to become easier to make.

Furthermore, it is assumed that the samples used as an example of the second diagnosis described above are three types of concrete in which styrene boards have different diameters and which imitate the measurement objects O having different defect sizes. On the other hand, the applicant has also performed the same second diagnosis on a plurality of types of concrete in which styrene boards have different cover thicknesses and which imitate the measurement object O having different depths of defects. As a result, the applicant has confirmed that the presence or absence of an abnormality can be diagnosed through the second diagnosis. That is, the presence or absence of various abnormalities may be diagnosed through the second diagnosis. To distinguish a difference in frequency characteristic due to a difference in defect size from a difference in frequency characteristic due to a difference in defect and depth, for example, not only the degree of abnormality but also a type of abnormality may be diagnosed by accumulating a database of a relationship between the degree of abnormality and a frequency characteristic for each type of abnormality and comparing the degree of similarity between the frequency characteristic in this database and a frequency characteristic of a diagnostic object.

As described above, according to the embodiment, an abnormality of a measurement object is diagnosed by utilizing the characteristic that the volume of the vibration radiation sound from the measurement object at the time of vibrating the measurement object with the excitation sound shifts from the dead zone to the rise area to the linear region to the saturation zone in this order according to the volume of excitation sound. As a result, it is possible to obtain the same level of accuracy in diagnosing a structure as in diagnosis using hammering sounds without contact.

### (Modifications)

Modifications of the embodiment will be described.

### (First Modification)

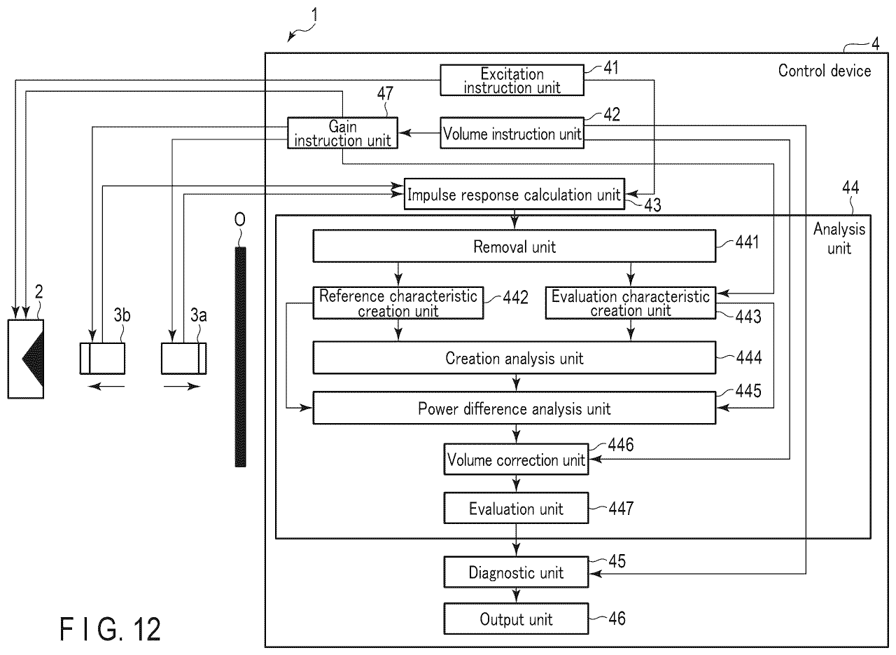

FIG. 12 is a block diagram illustrating a configuration of an example of a diagnostic apparatus according to a first modification of the embodiment. As with the embodiment, the diagnostic apparatus 1 of the first modification also includes the speaker 2, the microphones 3a and 3b, and the control device 4. The first modification differs in terms of configuration of the control device 4.

The control device 4 according to the first modification includes a gain instruction unit 47 in addition to the excitation instruction unit 41, the volume instruction unit 42, the impulse response calculation unit 43, the analysis unit 44, the diagnostic unit 45, and an output unit 46. The gain instruction unit 47 designates amplifier gains of the microphones 3a and 3b based on a volume designated by the volume instruction unit 42. Specifically, the gain instruction unit 47 decreases the amplifier gains of the microphones 3a and 3b in receipt of the instruction to increase the volume by the volume instruction unit 42. For example, in a case where the volume of the excitation sound is set to +3 dB, the gain instruction unit 47 sets the amplifier gains of the microphones 3a and 3b to −3 dB. Through this operation, a range of sound reception signals received by the microphones 3a and 3b remains constant regardless of the volume of the excitation sound. Therefore, the SN of the sound reception signal is maintained. Herein, a reference for the amplifier gains of the microphones 3a and 3b is set such that the range is from 0.1 V or greater and 1.0 V or smaller based on the volume reference of the excitation sound of the speaker 2.

In the configuration shown in FIG. 12, the gain of the sound reception signal is decreased. Thus, in order to obtain a correct frequency characteristic, correction is required for the decrease in the gain of the sound reception signal. For this purpose, the evaluation characteristic creation unit 443 holds, as the first evaluation characteristic and the second evaluation characteristic, the first evaluation impulse response and the second evaluation impulse response each corrected in gain. Specifically, the evaluation characteristic creation unit 443 adds a gain corresponding to the evaluation volume to each of the first evaluation impulse response and the second evaluation impulse response, and holds the resultant responses as the first evaluation characteristic and the second evaluation impulse response.

The first modification described above improves the SN of the sound reception signal. Therefore, improvement in diagnostic accuracy is expected.

### (Second Modification)

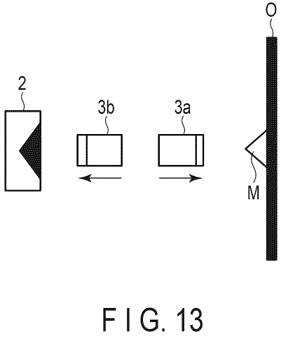

In the embodiment, the measurement object O is diagnosed in a completely non-contact manner. On the other hand, as shown in FIG. 13, the vibration radiation sound may be measured on the measurement object o to which applied mass M is attached. With the measurement object O with the applied mass M attached thereto, it is expected that the shift of the vibration radiation sound from the dead zone to the rise region to the linear region to the saturation zone can be captured more easily. Herein, the applied mass M may be any mass that can increase the mass of the measurement object O. Furthermore, the attachment of the applied mass M to the measurement object O may be performed by various methods suitable for the measurement object O, such as pasting on the measurement object O, coating, etc.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A diagnostic apparatus comprising:
an excitation unit configured to radiate an excitation sound to a measurement object;
a first sound reception unit arranged in a vicinity of the measurement object and configured to receive a sound including a vibration radiation sound of the measurement object caused by radiation of the excitation sound;
a second sound reception unit arranged in a vicinity of the excitation unit and configured to receive the excitation sound; and
a processor including hardware configured to:
designate a plurality of various volumes for the excitation unit;
calculate a first reference impulse response, a second reference impulse response, a first evaluation impulse response, and a second evaluation impulse response, the first reference impulse response being based on a first reference signal output from the first sound reception unit in response to radiation of an excitation sound with a reference volume at which the vibration radiation sound is not radiated from the measurement object, the second reference impulse response being based on a second reference signal output from the second sound reception unit in response to radiation of an excitation sound with the reference volume, the first evaluation impulse response being based on a first evaluation signal output from the first sound reception unit in response to radiation of excitation sounds with at least two evaluation volumes greater than the reference volume, and the second evaluation impulse response being based on a second evaluation signal output from the second sound reception unit in response to radiation of the excitation sounds with the evaluation volumes;
calculate a correlation transfer function between a second reference characteristic based on the second reference impulse response and a second evaluation characteristic based on the second evaluation impulse response;
calculate, based on the correlation transfer function, a difference between a first evaluation characteristic based on the first evaluation impulse response and a first reference characteristic based on the first reference impulse response; and
diagnose the measurement object based on the difference and a characteristic that a volume of the vibration radiation sound shifts from a dead zone to a rise region to a linear region to a saturation zone in this order as a volume of the excitation sound changes.

2. The diagnostic apparatus according to claim 1, wherein the processor is configured to:
identify a frequency band of interest in which a value of the difference is equal to or greater than a predetermined level in a frequency characteristic of the difference; and
diagnose the measurement object based on a difference between measurement objects including the measurement object in terms of how the volume of the vibration radiation sound in the frequency band of interest shifts from the dead zone to the rise region to the linear region to the saturation zone in this order as the volume of the excitation sound changes.

3. The diagnostic apparatus according to claim 1, wherein the processor is configured to:
identify an evaluation volume of interest in which a value of the difference belongs to the linear region within a range of certain frequencies in a frequency characteristic of the difference; and
diagnose the measurement object based on a difference between measurement objects including the measurement object in terms of a frequency characteristic of the different with respect to the evaluation volume of interest.

4. The diagnostic apparatus according to claim 1, wherein the processor is configured to further perform volume correction on the difference based on a difference between the reference volume and the evaluation volume.

5. The diagnostic apparatus according to claim 1, wherein the processor is configured to:
decrease gains of a first sound reception unit and a second sound reception unit in accordance with an instruction to increase the volume; and
perform gain correction on the first evaluation impulse response and the second evaluation impulse response in accordance with the gains of the first sound reception unit and the second sound reception unit.

6. The diagnostic apparatus according to claim 1, further comprising an applied mass to be attached to the measurement object.

7. A diagnostic method comprising:
radiating an excitation sound from an excitation unit to a measurement object;
designating a plurality of various volumes for the excitation unit;
calculating a first reference impulse response, a second reference impulse response, a first evaluation impulse response, and a second evaluation impulse response, the first reference impulse response being based on a first reference signal output from the first sound reception unit in response to radiation of an excitation sound with a reference volume at which the vibration radiation sound is not radiated from the measurement object, the second reference impulse response being based on a second reference signal output from the second sound reception unit in response to radiation of an excitation sound with the reference volume, the first evaluation impulse response being based on a first evaluation signal output from the first sound reception unit in response to radiation of excitation sounds with at least two evaluation volumes greater than the reference volume, and the second evaluation impulse response being based on a second evaluation signal output from the second sound reception unit in response to radiation of the excitation sounds with the evaluation volumes;
calculating a correlation transfer function between a second reference characteristic based on the second reference impulse response and a second evaluation characteristic based on the second evaluation impulse response;
calculating, based on the correlation transfer function, a difference between a first evaluation characteristic based on the first evaluation impulse response and a first reference characteristic based on the first reference impulse response; and
diagnosing the measurement object based on the difference and a characteristic that a volume of the vibration radiation sound shifts from a dead zone to a rise region to a linear region to a saturation zone in this order as a volume of the excitation sound changes.

8. A non-transitory computer-readable storage medium storing a diagnostic program for causing a computer to:
radiate an excitation sound from an excitation unit to a measurement object;
designate a plurality of various volumes for the excitation unit;
calculate a first reference impulse response, a second reference impulse response, a first evaluation impulse response, and a second evaluation impulse response, the first reference impulse response being based on a first reference signal output from the first sound reception unit in response to radiation of an excitation sound with a reference volume at which the vibration radiation sound is not radiated from the measurement object, the second reference impulse response being based on a second reference signal output from the second sound reception unit in response to radiation of an excitation sound with the reference volume, the first evaluation impulse response being based on a first evaluation signal output from the first sound reception unit in response to radiation of excitation sounds with at least two evaluation volumes greater than the reference volume, and the second evaluation impulse response being based on a second evaluation signal output from the second sound reception unit in response to radiation of the excitation sounds with the evaluation volumes;
calculate a correlation transfer function between a second reference characteristic based on the second reference impulse response and a second evaluation characteristic based on the second evaluation impulse response;
calculate, based on the correlation transfer function, a difference between a first evaluation characteristic based on the first evaluation impulse response and a first reference characteristic based on the first reference impulse response; and
diagnose the measurement object based on the difference and a characteristic that a volume of the vibration radiation sound shifts from a dead zone to a rise region to a linear region to a saturation zone in this order as a volume of the excitation sound changes.
